(19) United States
(12) Patent Application Publication
(10) Pub. No.: US 2020/0407639 A1
(43) Pub. Date: Dec. 31, 2020

(54) LIQUID CRYSTAL POLYMER FILM, AND COMPOSITE FILM OF LIQUID CRYSTAL POLYMER AND POLYIMIDE AND MANUFACTURING METHOD THEREOF

(71) Applicant: NAN YA PLASTICS CORPORATION, TAIPEI (TW)

(72) Inventors: TE-CHAO LIAO, TAIPEI (TW); SEN-HUANG HSU, TAIPEI (TW); CHAO-QUAN WU, TAIPEI (TW)

(21) Appl. No.: 16/662,272

(22) Filed: Oct. 24, 2019

(30) Foreign Application Priority Data
Jun. 28, 2019 (TW) 108122739

(51) Int. Cl. C09K 19/32; C09K 19/06; B32B 15/20; B32B 15/08; B32B 27/28; B32B 27/18; B32B 37/10; B32B 37/06

(52) U.S. Cl. CPC C09K 19/322; C09K 19/062; B32B 15/20; B32B 15/08; B32B 27/281; B32B 2305/72; B32B 37/10; B32B 37/06; C09K 2219/03; B32B 2305/55; B32B 27/18

(57) ABSTRACT

A liquid crystal polymer film, and a composite film of liquid crystal polymer and polyimide and a manufacturing method thereof are provided. The liquid crystal polymer film includes 63 wt % to 74 wt % of p-hydroxybenzoic acid, 21 wt % to 26 wt % of 6-hydroxy-2-naphthoic acid, and 5 wt % to 11 wt % of p-hydroxycinnamic acid. The composite film is manufactured by thermocompressing a single layer or multi layers of liquid crystal polymer film and polyimide film so that the composite film can have high flatness and the surface roughness Sa of the composite film is ranging from 0.1 μm to 10 μm. In the production process of the composite film, the composite film is rolled up and attached to a copper foil to form a high frequency substrate with good processability. After peeling the polyimide film, the liquid crystal polymer film can be thermocompressed to form a four-layered, six-layered, eight-layered or eight-layered high frequency substrate.

### CROSS-REFERENCE TO RELATED PATENT APPLICATION

This application claims the benefit of priority to Taiwan Patent Application No. 108122739, filed on Jun. 28, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a liquid crystal polymer film, and a composite film of liquid crystal polymer and polyimide and a manufacturing method thereof, and more particularly to a liquid crystal polymer film, and a composite film of liquid crystal polymer and polyimide and a manufacturing method thereof for ultra-high frequency substrates which can be applied to aerospace communication using 120 GHz ultra-high frequency.

### BACKGROUND OF THE DISCLOSURE

With the development of optics and photonic, aerospace, national defense, and mobile communication technologies using high frequency transmission (60 GHz to 120 GHz), requirements to high-performance engineering plastics are increasing. Liquid crystal polymer has advantages of low hygroscopicity, high chemical tolerance, high gas barrier property, and low dielectric constant/dielectric dissipation (Dk/Df) so that liquid crystal polymer has been one of the main materials for development. Recently, ultra-high frequency transmission in aerospace field has thrived, causing a need for the transmission speed of the substrate to be increased and a need for the transmission loss of the substrate on high frequency to be reduced, so as to enhance the signal transmission speed. The lower the dielectric constant is, the higher the signal transmission speed is. Therefore, lowering the dielectric constant of the substrate and lowering the deformation ratio of waveform of the substrate are objectives for development of the high frequency substrate with low dielectric constant.

A ceramic material is a well-known material for the high frequency substrate with low dielectric constant. However, the ceramic material is hard to be processed and the price of ceramic material is expensive. Accordingly, in order to replace the ceramic material, a fluorine-containing resin with good dielectric properties, such as polytetrafluoroethylene (PTFE), is used to serve as the substrate of the electrical insulation layer and polyimide with good thermal tolerance is used to serve as the electrical insulation layer. As for a PTFE substrate, the PTFE substrate has excellent high frequency properties and low wet fastness. Nevertheless, a glass cloth is usually added in the PTFE substrate to improve the dimensional stability of the PTFE substrate. The addition of the glass cloth decreases the frequency properties and wet fastness of the PTFE substrate. As for a polyimide substrate, the frequency properties and the wet fastness of the polyimide substrate are lower than those of the PTFE substrate. Further, the high hygroscopicity may worsen the signal transmission of the high frequency substrate.

In addition to the loss of the conductor, the dielectric dissipation is also related to the transmission loss of high frequency signal. Therefore, an insulating substrate material with excellent dielectric property is required so as to reduce the transmission loss of high frequency signal, and enhance the information processing speed and signal transmission speed.

There is an increasing market for manufacturing a printed circuit board by using the liquid crystal polymer film whose dielectric dissipation is lower than dielectric dissipation of the polyimide film serving as the insulating substrate, and then thermocomopressing the liquid crystal polymer film onto a conductive layer.

According to the disclosure of Taiwan (R.O.C.) Patent Publication No. TW201702067, the surface roughness of the conductive layer is increased and the disposition of the insulating layer, such as liquid crystal polymer film, is decreased in order to enhance the anchoring effect (i.e., focalism) of the conductive layer. However, the high frequency properties of the printed circuit board will be worsened.

According to the disclosure of China (P.R.C.) Patent Publication No. CN103917582, a printed circuit board can have good dielectric property at a condition of high temperature and high humidity.

According to the disclosure of China (P.R.C.) Patent Publication No. CN1488489A, production equipment for film blowing is provided. The production equipment includes a circular die, a cooling ring, and a wind ring. The production equipment for film blowing can control the mass change of the blown film and restrain the melted film from oscillating.

Producing plastic films by film blowing has developed for over 30 years and is extensively applied. For example, low density polyethylene (LDPE), high density polyethylene (HDPE), linear low density polyethylene (LLDPE), polypropylene (PP), polyvinyl chloride (PVC), and thermoplastic liquid crystal polyester (thermoplastic LCP) are all suitable to produce plastic film by a blown film machine.

### SUMMARY OF THE DISCLOSURE

In response to the above-referenced technical inadequacies, the present disclosure provides a liquid crystal polymer film, and a composite film of liquid crystal polymer and polyimide and a manufacturing method thereof.

In one aspect, the present disclosure provides a liquid crystal polymer film including 63 wt % to 74 wt % of p-hydroxybenzoic acid, 21 wt % to 26 wt % of 6-hydroxy-2-naphthoic acid, and 5 wt % to 11 wt % of p-hydroxycinnamic acid.

In one aspect, the present disclosure provides a composite film of liquid crystal polymer and polyimide. The composite film of liquid crystal polymer and polyimide includes a liquid crystal polymer film and a polyimide film. The liquid crystal polymer film contains 63 wt % to 74 wt % of p-hydroxybenzoic acid, 21 wt % to 26 wt % of 6-hydroxy-2-naphthoic acid, and 5 wt % to 11 wt % of p-hydroxycinnamic acid. The polyimide film disposed on the liquid crystal polymer film through a thermocompression process. The polyimide film is capable of separating from the liquid crystal polymer film.

Preferably, a surface roughness Sa of the liquid crystal polymer film is from 0.1 μm to 10 μm.

Preferably, a dielectric constant of the composite film of liquid crystal polymer and polyimide ranges from 1 to 5.

Preferably, a dielectric dissipation of the composite film of liquid crystal polymer and polyimide ranges from 0.0001 to 0.12.

In one aspect, the present disclosure provides a method for manufacturing a composite film of liquid crystal polymer and polyimide. The method for manufacturing a composite film of liquid crystal polymer and polyimide includes steps of: providing a liquid crystal polymer containing 63 wt % to 74 wt % of p-hydroxybenzoic acid, 21 wt % to 26 wt % of 6-hydroxy-2-naphthoic acid, and 5 wt % to 11 wt % of p-hydroxycinnamic acid; and disposing the liquid crystal polymer on a polyimide film through a thermocompression process to form the composite film of liquid crystal polymer and polyimide.

Preferably, a set temperature of the thermocompression process ranges from 150° C. to 360° C.

Preferably, a set pressure of the thermocompression process ranges from 10 kg/cm² to 3000 kg/cm².

Preferably, duration of the thermocompression process ranges from 5 seconds to 60 seconds.

The liquid crystal polymer film, and the composite film of liquid crystal polymer and polyimide and the manufacturing method thereof are specially suitable to be applied to an aerospace industrial antenna system. For example, the antenna can be manufactured from a four-layered structure of copper foil/liquid crystal polymer/liquid crystal polymer/copper foil or a structure having more than four layers (as shown in FIGS. 2 and 3). The dielectric dissipation of the antenna of a high frequency transmission system applied to the aerospace industry will be dramatically influenced by weather, so that the dielectric dissipation of the antenna is hard to be maintained at an environment of high temperature and high humidity. The present disclosure is mainly applied to the high frequency transmission system, such as a frequency range of 60 GHz to 120 GHz or a frequency higher than 120 GHz. The component of the liquid crystal resin includes p-hydroxybenzoic acid, 6-hydroxy-2-naphthoic acid, and p-hydroxycinnamic acid. Further, the liquid crystal resin is manufactured through polymerization, granulation, and blowing film. Specifically, p-hydroxybenzoic acid, 6-hydroxy-2-naphthoic acid, and p-hydroxycinnamic acid are mixed at a temperature of 285° C. to 300° C. to form the liquid crystal resin and then the liquid crystal resin is extruded through a blown film die with a diameter of 180 mm to form a liquid crystal polymer film with a thickness of 50 μm. In the process of extrusion of the liquid crystal polymer film, molecules of the liquid crystal polymer will be arranged along a direction of extrusion (machine direction, MD). Therefore, the physical properties of the liquid crystal polymer film in machine direction (MD) are different from the physical properties of the liquid crystal polymer film in transverse direction (TD) vertical to MD. In other words, the physical properties on machine direction and on transverse direction of the liquid crystal polymer film can respectively be controlled by adjusting the stretch ratios on machine direction and on transverse direction.

Wrinkles formed in the process of film blowing process will negatively impact the dielectric dissipation of the antenna for high frequency transmission. Therefore, before the liquid crystal polymer film is cooled and formed, the two sides of the liquid crystal polymer film on transverse direction are fixed by the laminating equipment so as to keep the liquid crystal polymer film flat and prevent the formation of wrinkles. Accordingly, the yield of the production of the liquid crystal polymer film can be increased and the flatness of the liquid crystal polymer film can be enhanced.

[UV Light Irradiation to Increase the Crosslinking Density]

Under the irradiation of UV light, photochemical reaction will occur on carbon-carbon double bonds so that the degree of crosslinking will increase. For example, the UV light can be a UV light with a single wavelength of 185 nm, a UV light with single wavelength of 254 nm, or a UV light with various wavelengths. For example, the UV light can be a UV light with wavelengths of 185 nm and 254 nm.

[Thermocompression]

The present disclosure provides a method for manufacturing the composite film of liquid crystal polymer and polyimide suitable for the aerospace industry. The liquid crystal polymer film and the polyimide film are thermocompressed by a double steel belt thermocompressor machine (having two steel plates respectively disposed on a relative top end and a relative bottom end; the set temperature being 250° C. and the set pressure being 50 kg/cm²) so that the liquid crystal polymer film can be adhered to the polyimide film, and the polyimide film is capable of being peeled from the liquid crystal polymer film without residue. Due to there being no residue on the liquid crystal polymer film, the liquid crystal polymer film is easy to be thermocompressed to form a multi-layered plate which has better heat tolerance, solvent resistance, wet fastness, and weather resistance and more extensive application than those of conventional high frequency substrate.

The two steel plates of the double steel belt thermocompressor machine are polished. The liquid crystal polymer film can be thermocompressed onto the polyimide film by the double steel belt machine as shown in FIG. 6. The highest set temperature of the double steel belt machine is 400° C. and the highest set pressure of the double steel belt machine is 200 kg/cm².

To overcome the drawbacks and deficiencies in conventional technology, the present disclosure provides a composite film of liquid crystal polymer and polyimide with high flatness which has good processability. Therefore, the high frequency substrate is easy to be patterned different circuits and be processed in the manufacturing process.

The aim of the present disclosure is realized by the composite film of liquid crystal polymer and polyimide applied to ultra-high frequency ranging from 60 GHz to 120 GHz. The composite film of liquid crystal polymer and polyimide can be used to manufacture a four-layered high frequency substrate, a six-layered high frequency substrate, an eight-layer high frequency substrate, or a high frequency substrate including more than eight layers

Specifically, the thickness of the copper foil ranges from 12 μm to 70 μm. The thickness of the liquid crystal polymer film ranges from 25 μm to 100 μm. The thickness of the polyimide film ranges from 50 μm to 125 μm.

Referring to FIG. 2, the four-layered printed circuit board includes copper foil/liquid crystal polymer film/liquid crystal polymer film/copper foil. The thickness of the four-layered printed circuit board ranges from 25 μm to 250 μm; preferably, the thickness of the four-layered printed circuit board ranges from 100 μm to 150 μm. Referring to FIG. 3, the six-layered printed circuit board includes copper foil/liquid crystal polymer film/copper foil/liquid crystal polymer film/liquid crystal polymer film/copper foil. The thickness of the six-layered printed circuit board ranges from 75 μm to 300 μm; preferably, the thickness of the six-layered printed circuit board ranges from 150 μm to 200 μm. The eight-layer printed circuit board includes copper foil/liquid crystal polymer film/copper foil/liquid crystal polymer film/copper foil/liquid crystal polymer film/liquid crystal polymer film/copper foil. The thickness of the eight-layered printed circuit board ranges from 100 μm to 400 μm; preferably, the thickness of the eight-layered printed circuit board ranges from 200 μm to 300 μM.

Referring to FIG. 1, a copper clad laminate includes a copper foil 10, a liquid crystal polymer film 20, and a polyimide film 30. The copper clad laminate can be further thermocompressed and then formed a four-layered high frequency substrate, a six-layered high frequency substrate, an eight-layer high frequency substrate, or a high frequency substrate including more than eight layers.

The copper foil 10 can be a copper foil manufactured by Nan Ya Plastics Corporation whose model is FR-4, FR-5, TLC-V, or TLC-H. The thickness of the copper foil 10 ranges from 12 μm to 70 μm.

The liquid crystal polymer film 20 is prepared through a film blowing method. The two sides of the liquid crystal polymer film 20 are fixed by the laminating equipment to reduce the formation of wrinkles. In addition, the crystallinity of the liquid crystal polymer film 20 can be increased during a slow cooling process. The schematic views of the blown film machine with laminating equipment are illustrated in FIGS. 4 and 5.

The continuously rolled up liquid crystal polymer film is thermocompressed with the polyimide film to form the composite film of liquid crystal polymer and polyimide by the double steel belt thermocompressor machine. After being heated in an oven, the composite film of liquid crystal polymer and polyimide is rolled up as shown in FIG. 6 so that the aim stated above can be achieved.

The double steel belt thermocompressor machine is used in the present disclosure. To meet the standard of ultra-high frequency of 60 GHz to 120 GHz, the flatness of the composite film of liquid crystal film and polyimide can be increased by setting the temperature of the double steel belt thermocompressor machine being 250° C. Further, the dielectric constant (Dk) of the composite film of liquid crystal film and polyimide can be lowered to have good performance in ultra-high frequency transmission. In the present disclosure, the dielectric constant of the composite film is from 1 to 5; preferably, the dielectric constant of the composite film is from 1.2 to 3.7; much preferably, the dielectric constant of the composite film is from 1.8 to 3.6.

The double steel belt thermocompressor machine is used in the present disclosure. To meet the standard of ultra-high frequency of 60 GHz to 120 GHz, the flatness of the composite film of liquid crystal film and polyimide can be increased by setting the temperature of the double steel belt thermocompressor machine being 250° C. Further, the dielectric dissipation (Df) of the composite film can be lowered to have good performance on ultra-high frequency transmission. In the present disclosure, the dielectric dissipation of the composite film is from 0.0001 to 0.12; preferably, the dielectric dissipation of the composite film is from 0.0005 to 0.032; much preferably, the dielectric dissipation of the composite film is from 0.001 to 0.003.

Considering the complex processability in downstream processing, the liquid crystal polymer film and the polyimide film will be manufactured into a composite film in advance to enhance the efficiency and lower the cost.

The liquid crystal polymer film, and the composite film of liquid crystal polymer and polyimide and the manufacturing method thereof of the present disclosure has the technical feature of “regulating the component and content of the liquid crystal film” to maintain the dielectric constant of the composite film higher than or equal to 3.0 and the dielectric dissipation of the composite film lower than or equal to 0.003. Therefore, the composite film of liquid crystal polymer and polyimide can be applied to the high frequency substrate so as to provide good processability to the high frequency substrate.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a cross-sectional view of a copper clad laminate of the present disclosure.

FIG. 2 is a cross-sectional view of a four-layered printed circuit board of the present disclosure.

FIG. 3 is a cross-sectional view of a six-layered printed circuit board of the present disclosure.

FIG. 4 is a side view of a blown film machine with laminating equipment.

FIG. 5 is a partial enlarged view of section V of FIG. 4.

FIG. 6 is a schematic view of a double steel belt thermocompressor.

FIG. 7 is a flowchart of a method for manufacturing a composite film of liquid crystal polymer and polyimide of the present disclosure.

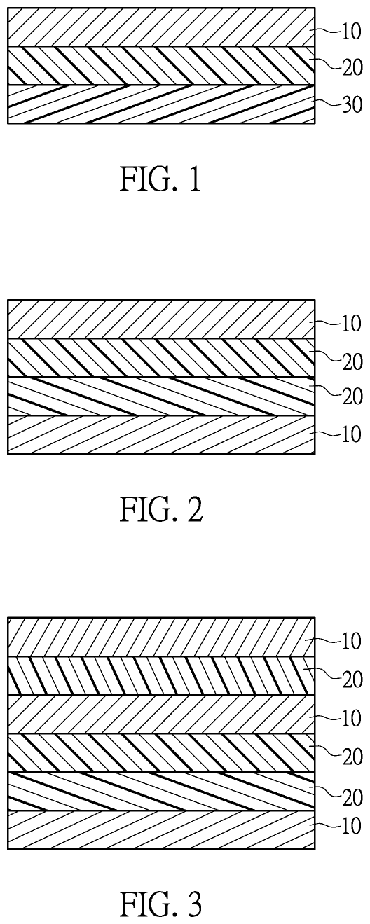

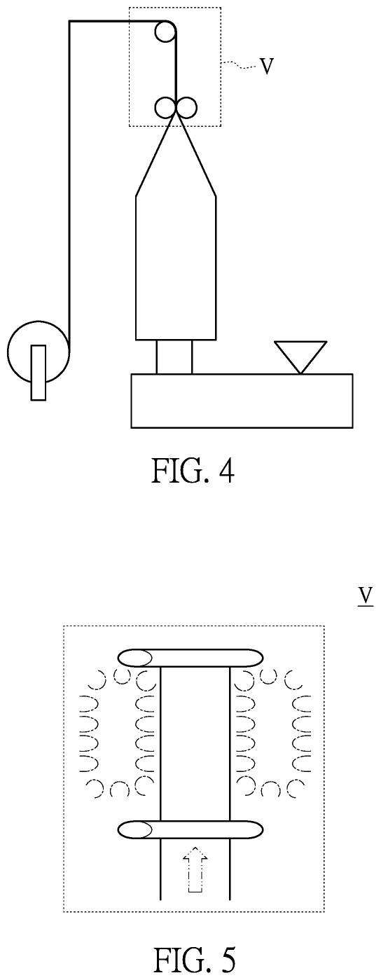

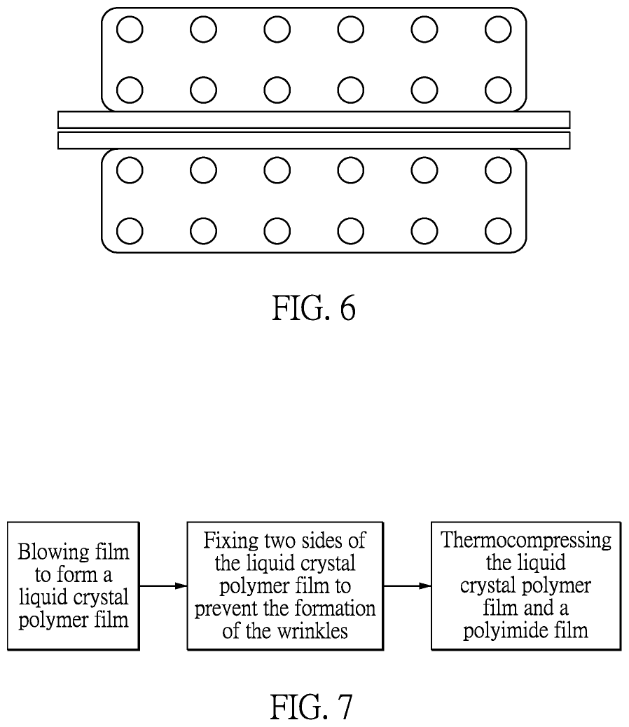

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

A liquid crystal polymer is provided. The liquid crystal polymer film includes:

A. 63 wt % to 74 wt % of p-hydroxybenzoic acid;

B. 21 wt % to 26 wt % of 6-hydroxy-2-naphthoic acid; and

C. 5 wt % to 11 wt % of p-hydroxycinnamic acid.

The liquid crystal polymer film is produced by a blown film machine and is continuously rolled up by film laminating equipment. Two sides of the liquid crystal polymer film are fixed by the film laminating equipment so as to prevent the liquid crystal polymer film from deforming, forming wrinkles, and being hardened or embrittled due to a drop of temperature which may negatively impact the quality of the liquid crystal polymer film Subsequently, the liquid crystal polymer film is exposed to UV light, thermocompressing onto a polyimide film to form a composite film by a double steel belt thermocompressor. After being heated by a heater, the composite film is rolled up to complete the method for manufacturing the composite film of liquid crystal polymer and polyimide and to achieve the aim stated above. Further, properties of the composite film of liquid crystal polymer and polyimide are stable and will not change over time. The composite film of liquid crystal polymer and polyimide manufactured by the method of the present disclosure is flat and has few wrinkles.

The monomer in the liquid crystal resin to polymerize the liquid crystal polymer of the present disclosure is selected from the group consisting of a benzene ring, a naphthalene ring, and monomers including a benzene structure or a naphthalene structure with good heat resistance. Further, the main reacting functional group of the monomer is hydroxyl group or carboxylic acid group. In some embodiments, the monomer is modified by branched vinyl group, terminally branched hexenyl group, or terminally and medially branched vinyl group. In a preferable embodiment, the monomer can be p-hydroxycinnamic acid including medially branched vinyl group. The preferable addition amount of p-hydroxycinnamic acid is 5 wt % to 11 wt %. A more specific illustration thereof is provided below.

[UV Light Irradiation to Increase the Crosslinking Density]

After forming the liquid crystal polymer film in the step of blowing film, the liquid crystal polymer film is exposed to ultraviolet (UV) light to proceed photochemical reaction on carbon-carbon double bonds so that the degree of crosslinking of the liquid crystal polymer film can be increased. Specifically, the UV light can be a UV light with a single wavelength of 185 nm, a UV light with single wavelength of 254 nm, or a UV light with various wavelengths. For example, the UV light can be a UV light with wavelengths of 185 nm and 254 nm.

It should be noted that the composite film of liquid crystal polymer and polyimide of the present disclosure is manufactured by disposing a liquid crystal polymer film on a polyimide film, instead of mixing liquid crystal polymer with polyimide to form a mixed film After the step of blowing film, if the thickness of the liquid crystal polymer film is thicker than 150 μm, the liquid crystal polymer film will have a disadvantage of having a rough surface. If the thickness of the liquid crystal polymer film is thinner than 15 μm, the liquid crystal polymer film cannot be provided with high dielectric constant (Dk) and low dielectric dissipation (Df).

In the thermocompression process, the liquid crystal polymer film is thermocompressed on a polyimide film at a temperature ranging from 150° C. to 360° C. by a double steel belt thermocompressor. In a preferable embodiment, the temperature range regulated in the thermocompression process is from 200° C. to 320° C. In addition, duration time regulated in the thermocompression process is over 5 seconds; preferably, duration time regulated in the thermocompression process is over 8 seconds so as to form the composite film. The thickness of the composite film can range from 20 μm to 300 μm; preferably, the thickness of the composite film can range from 30 μm to 200 μm.

1. Thickness Measurement

A square sample with a length of 50 mm is cut from a central part of the liquid crystal polymer film. The square sample is measured by a film thickness consecutive tester (Fuji, S-2268) over 30 cm at machine direction (MD) and 30 cm at transverse direction (TD) so that an average longitudinal thickness and an average lateral thickness of the square sample can be obtained.

2. Thickness Uniformity

A square sample with a length of 50 mm is cut from a central part of the liquid crystal polymer film. The square sample is measured by a film thickness consecutive tester (Fuji, S-2268) over 30 cm at machine direction (MD) and 30 cm at transverse direction (TD) so that an average longitudinal thickness and an average lateral thickness of the square sample can be obtained. A value to analyze the thickness uniformity is a difference between the maximum thickness and the minimum thickness.

3. Average Roughness Sa

The average roughness Sa is measured by a non-contact surface roughness detector (Laser Micro scope VK-X1000) to process an optical microscope analysis. The measuring conditions are listed below:

(a) magnification: 50×24;

(b) measuring length: 282 μm; and

(c) measuring width: 247 μm.

4. Wrinkles of the Liquid Crystal Polymer Film

A sample in a size of A4 is cut from the liquid crystal polymer film to serve as a sample. The appearance of the sample is observed by naked eye and evaluated according to standards below.

◯: the flatness of the liquid crystal polymer film is good as an amount of the wrinkles on the liquid crystal polymer film is 0 to 1;

Δ: the flatness of the liquid crystal polymer film is normal as an amount of the wrinkles on the liquid crystal polymer film is 2 to 3;

X: the flatness of the liquid crystal polymer film is bad as an amount of the wrinkles on the liquid crystal polymer film is over 3.

5. Measurement of Dielectric Constant

The dielectric constant of the liquid crystal polymer film is measured by a vector network analyzer (Anritsu, ME7838E) at a frequency of 101 GHz.

6. Measurement of Dielectric Dissipation

The dielectric dissipation of the liquid crystal polymer film is measured by a vector network analyzer (Anritsu, ME7838E) at a frequency of 105 GHz.

Examples below are provided for illustration of the embodiments. However, the example illustrated above is only one of the available embodiments and should not be taken as limitation of the scope of the present disclosure.

### Example 1

The liquid crystal resin includes: A. p-hydroxybenzoic acid; B. 6-hydroxy-2-naphthoic acid; and C. p-hydroxycinnamic acid. The mass ratio of A/B/C is 68/24/8.

Referring to FIG. 7, the liquid crystal polymer film is prepared by a blown film machine. Two sides the liquid crystal polymer film are fixed by the film laminating equipment of the blown film machine so that the liquid crystal polymer film will not generate wrinkles or deform due to a drop of temperature and will have a flat surface with no wrinkles.

The liquid crystal polymer film with a thickness of 50 μm is exposed to UV light to increase the degree of crosslinking Subsequently, the liquid crystal polymer film is thermocompressed on a polyimide film with a thickness of 50 μm by a double steel belt thermocompressor so that the composite film of liquid crystal polymer and polyimide is formed and the adhesive force between the liquid crystal polymer film and the polyimide film is good. The double steel belt thermocompressor has two steel plates respectively disposed on a relative top end and a relative bottom end. In Example 1, the set temperature of the double steel belt thermocompressor is 250° C. and the set pressure of the double steel belt thermocompressor is 50 kg/cm². The various physical properties of the composite film of liquid crystal polymer and polyimide are listed in Table 1.

### Example 2

The composite film of liquid crystal polymer and polyimide in Example 2 is manufactured by a similar method as illustrated in Example 1. The difference between Example 2 and Example 1 is that the mass ratio of A/B/C in the liquid crystal resin is 70/24/6. The liquid crystal resin is used to form the liquid crystal polymer film by the blown film machine.

The liquid crystal polymer film with a thickness of 50 μm is exposed to UV light to increase the degree of crosslinking Subsequently, the liquid crystal polymer film is thermocompressed on a polyimide film with a thickness of 75 μm by the double steel belt thermocompressor so that the composite film of liquid crystal polymer and polyimide is formed. The double steel belt thermocompressor has two steel plates respectively disposed on a relative top end and a relative bottom end. In Example 2, the set temperature of the double steel belt thermocompressor is 230° C. and the set pressure of the double steel belt thermocompressor is 100 kg/cm². The various physical properties of the composite film of liquid crystal polymer and polyimide are listed in Table 1.

### Example 3

The composite film of liquid crystal polymer and polyimide in Example 3 is manufactured by a similar method as illustrated in Example 1. The difference between Example 3 and Example 1 is that the mass ratio of A/B/C in the liquid crystal resin is 73/25/2. The liquid crystal resin is used to form the liquid crystal polymer film by the blown film machine.

The liquid crystal polymer film with a thickness of 25 μm is exposed to UV light to increase the degree of crosslinking Subsequently, the liquid crystal polymer film is thermocompressed on a polyimide film with a thickness of 50 μm by the double steel belt thermocompressor so that the composite film of liquid crystal polymer and polyimide is formed and the adhesive force between the liquid crystal polymer film and the polyimide film is good. The double steel belt thermocompressor has two steel plates respectively disposed on a relative top end and a relative bottom end. In Example 3, the set temperature of the double steel belt thermocompressor is 230° C. and the set pressure of the double steel belt thermocompressor is 80 kg/cm². The various physical properties of the composite film of liquid crystal polymer and polyimide are listed in Table 1.

### Comparative Example 1

The composite film of liquid crystal polymer and polyimide in Comparative Example 1 is manufactured by a similar method as illustrated in Example 1. The difference between Comparative Example 1 and Example 1 is that the mass ratio of A/B/C in the liquid crystal resin is 60/20/20. The liquid crystal resin is used to form the liquid crystal polymer film by the blown film machine.

The liquid crystal polymer film with a thickness of 75 μm is exposed to UV light to increase the degree of crosslinking Subsequently, the liquid crystal polymer film is thermocompressed on a polyimide film with a thickness of 100 μm by the double steel belt thermocompressor so that the composite film of liquid crystal polymer and polyimide is formed and the adhesive force between the liquid crystal polymer film and the polyimide film is good. The double steel belt thermocompressor has two steel plates respectively disposed on a relative top end and a relative bottom end. In Comparative Example 1, the set temperature of the double steel belt thermocompressor is 260° C. and the set pressure of the double steel belt thermocompressor is 100 kg/cm². The various physical properties of the composite film of liquid crystal polymer and polyimide are listed in Table 1.

### Comparative Example 2

The composite film of liquid crystal polymer and polyimide in Comparative Example 2 is manufactured by a similar method as illustrated in Example 1. The difference between Comparative Example 2 and Example 1 is that the mass ratio of A/B/C in the liquid crystal resin is 50/40/10. The liquid crystal resin is used to form the liquid crystal polymer film by the blown film machine.

The liquid crystal polymer film with a thickness of 100 μm is exposed to UV light to increase the degree of crosslinking Subsequently, the liquid crystal polymer film is thermocompressed on a polyimide film with a thickness of 125 μm by the double steel belt thermocompressor so that the composite film of liquid crystal polymer and polyimide is formed and the adhesive force between the liquid crystal polymer film and the polyimide film is good. The double steel belt thermocompressor has two steel plates respectively disposed on a relative top end and a relative bottom end. In Comparative Example 2, the settemperature of the double steel belt thermocompressor is 270° C. and the set pressure of the double steel belt thermocompressor is 100 kg/cm². The various physical properties of the composite film of liquid crystal polymer and polyimide are listed in Table 1.

TABLE 1

| | | | Comparative | |
|---|---|---|---|---|
| Example | | | Example | |
| 1 | 2 | 3 | 1 | 2 |

Liquid crystal polymer film

| | | | | | |
|---|---|---|---|---|---|
| Mass ratio of | 68/24/8 | 70/24/6 | 73/25/2 | 60/20/20 | 50/40/10 |
| A/B/C | | | | | |
| Thickness (μm) | 50 | 50 | 25 | 75 | 100 |
| Uniformity of | 3.5 | 4 | 3.8 | 6 | 8 |
| thickness(μm) | | | | | |
| Surface | 2.4 | 2.8 | 2.6 | 3.1 | 4.3 |
| roughness(μm) | | | | | |
| Wrinkles | ◯ | Δ | Δ | X | X |
| evaluation | | | | | |

Polyimide film

| | | | | | |
|---|---|---|---|---|---|
| Thickness (μm) | 50 | 75 | 50 | 100 | 125 |

Thermocompression parameters

| | | | | | |
|---|---|---|---|---|---|
| Temperature | 250 | 230 | 230 | 260 | 270 |
| (° C.) | | | | | |
| Pressure | 50 | 100 | 80 | 100 | 100 |
| (kg/cm²) | | | | | |
| Duration | 8 | 15 | 6 | 20 | 25 |
| (second) | | | | | |

Dielectric properties of the composite film

| | | | | | |
|---|---|---|---|---|---|
| Dk (101 GHz) | 3.4 | 3.5 | 3.6 | 3.8 | 3.9 |
| Df (101 GHz) | 0.0021 | 0.0025 | 0.003 | 0.0032 | 0.0039 |

[Results and Discussion]

According to results, a preferable component and content of the liquid crystal resin includes A. 68 wt % of p-hydroxybenzoic acid; B. 24 wt % of 6-hydroxy-2-naphthoic acid; and C. 8 wt % of p-hydroxycinnamic acid. The liquid crystal resin is used to form the liquid crystal polymer film by the blown film machine. The liquid crystal polymer film is exposed to UV light to process photochemical reaction on carbon-carbon double bonds so that the degree of crosslinking and the toughness of the liquid crystal polymer film can be increased. If the content of C. p-hydroxycinnamic acid is larger than 20 wt %, the liquid crystal polymer film will be hardened and embrittled after the UV irradiation. If the content of C. p-hydroxycinnamic acid is smaller than 5 wt %, the texture of the liquid crystal polymer film will be soft.

In the thermocompressing process, the double steel belt thermocompressor machine has two steel plates respectively disposed on a relative top end and a relative bottom end. The liquid crystal polymer film and the polyimide film are thermocompressed to form the composite film. If the set temperature of the double steel belt thermocompressor is over 279° C., the liquid crystal polymer film cannot separate from the polyimide film. If the set temperature of the double steel belt thermocompressor is lower than 100° C., the liquid crystal polymer film will tend to peel from the polyimide film easily.

In conclusion, the liquid crystal polymer film, and the composite film of liquid crystal polymer and polyimide and the manufacturing method thereof of the present disclosure have the technical feature of “regulating the component and content of the liquid crystal film” to maintain the dielectric constant of the composite film higher than or equal to 3.0 and the dielectric dissipation of the composite film lower than or equal to 0.003. Therefore, the composite film of liquid crystal polymer and polyimide can be applied to the high frequency substrate so as to provide good processability to the high frequency substrate.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A liquid crystal polymer film, comprising:
63 wt % to 74 wt % of p-hydroxybenzoic acid;
21 wt % to 26 wt % of 6-hydroxy-2-naphthoic acid; and
5 wt % to 11 wt % of p-hydroxycinnamic acid.

2. The liquid crystal polymer film according to claim 1, wherein a surface roughness Sa of the liquid crystal polymer film is from 0.1 μm to 10 μm.

3. A composite film of liquid crystal polymer and polyimide, comprising:
a liquid crystal polymer film containing 63 wt % to 74 wt % of p-hydroxybenzoic acid, 21 wt % to 26 wt % of 6-hydroxy-2-naphthoic acid, and 5 wt % to 11 wt % of p-hydroxycinnamic acid; and
a polyimide film disposed on the liquid crystal polymer film through a thermocompression process; wherein the polyimide film is capable of separating from the liquid crystal polymer film.

4. The composite film according to claim 3, wherein a thickness of the composite film ranges from 20 μm to 300 μm.

5. The composite film according to claim 3, wherein a dielectric constant of the composite film of liquid crystal polymer and polyimide ranges from 1 to 5.

6. The composite film according to claim 3, wherein a dielectric dissipation of the composite film of liquid crystal polymer and polyimide ranges from 0.0001 to 0.12.

7. A method for manufacturing a composite film of liquid crystal polymer and polyimide, comprising steps of:
providing a liquid crystal polymer containing 63 wt % to 74 wt % of p-hydroxybenzoic acid, 21 wt % to 26 wt % of 6-hydroxy-2-naphthoic acid, and 5 wt % to 11 wt % of p-hydroxycinnamic acid; and
disposing the liquid crystal polymer on a polyimide film through a thermocompression process to form the composite film of liquid crystal polymer and polyimide.

8. The method according to claim 7, wherein a set temperature of the thermocompression process ranges from 150° C. to 360° C.

9. The method according to claim 7, wherein a set pressure of the thermocompression process ranges from 10 kg/cm² to 3000 kg/cm².

10. The method according to claim 7, wherein duration of the thermocompression process ranges from 5 seconds to 60 seconds.
